(19) United States
(12) Patent Application Publication
(10) Pub. No.: US 2026/0196074 A1
(43) Pub. Date: Jul. 9, 2026

(54) FINGERPRINT SENSOR SUBSTRATE AND FINGERPRINT SENSOR PACKAGE COMPRISING SAME

(71) Applicant: LG INNOTEK CO., LTD., Seoul (KR)

(72) Inventors: Sang Kyu LEE, Seoul (KR); Jun Young LIM, Seoul (KR); Hyung Kyu YOON, Seoul (KR); Min Kyu LEE, Seoul (KR)

(21) Appl. No.: 19/130,733

(22) PCT Filed: Oct. 30, 2023
(86) PCT No.: PCT/KR2023/017040

§ 371 Date: May 16, 2025

(30) Foreign Application Priority Data
Nov. 16, 2022 (KR) 10-2022-0153748
Jan. 11, 2023 (KR) 10-2023-0004279

(51) Int. Cl. G06V 40/13

(52) U.S. Cl. CPC G06V 40/1306

(57) ABSTRACT

A fingerprint sensor substrate according to an embodiment includes a substrate including a first surface and a second surface opposite to the first surface; a first sensing electrode disposed on the first surface and extending in a first direction; a second sensing electrode disposed on the second surface and extending in a second direction intersecting the first direction; a first wiring electrode connected to the first sensing electrode; and a second wiring electrode connected to the second sensing electrode, wherein the first sensing electrode and the second sensing electrode are disposed on a valid region of the substrate, wherein the first wiring electrode and the second wiring electrode are disposed on a non-valid region of the substrate, wherein the substrate includes a first component mounting region and a second component mounting region, wherein a plurality of pad parts are disposed inside and outside the first component mounting region and the second component mounting region, wherein the pad part includes: a first pad part disposed inside the first component mounting region and connected to the first wiring electrode; a second pad part disposed inside the first component mounting region and connected to the second wiring electrode; a third pad part disposed inside the second component mounting region; and a fifth pad part disposed outside the first component mounting region and the second component mounting region, and wherein a first wiring part and a second wiring part are disposed on at least one surface of the first surface and the second surface, wherein the first wiring part extends from the third pad part to an end of the substrate, wherein the second wiring part includes: a second-first wiring part connecting the third pad part and the fifth pad part; and a second-second wiring part extending from the fifth pad part in an end direction of the substrate, and wherein the second-second wiring part extends from the fifth pad part to the end of the substrate.

### TECHNICAL FIELD

An embodiment relates to a fingerprint sensor substrate and a fingerprint sensor package comprising same.

### BACKGROUND ART

A fingerprint sensor package senses a human fingerprint. The fingerprint sensor package is applied to a portable electronic device such as a smartphone or a smart IC card. Accordingly, a security of the portable electronic device and the smart IC card can be enhanced.

The fingerprint sensor package includes a fingerprint recognition module. The fingerprint recognition module requires a user registration or security authentication procedure. Accordingly, the fingerprint sensor package protects data stored in the portable electronic device or the smart IC card. In addition, it prevents security accidents.

The fingerprint sensor package includes an optical sensor, a capacitive sensor, an ultrasonic sensor, or a thermal sensor according to a fingerprint sensing principle. The fingerprint sensor package acquires fingerprint image data according to each operating principle.

The fingerprint sensor package can check electrical characteristics before being applied to an electronic device. For example, an inspection device including a wire probe contacts a pad part of the fingerprint sensor package. Thereby, it is checked whether the electrode is opened or shorted. Accordingly, the electrical characteristics of the fingerprint sensor package can be checked before using the electronic device.

However, a size of some pad parts may be too small to be inspected with a wire probe. Alternatively, some adjacent pad parts may be misaligned. Accordingly, there is a problem that it is difficult to perform an AEI (Auto Electric Inspection) process using wire probe equipment.

Therefore, a new structure of a fingerprint sensor substrate, a fingerprint sensor package, and an electronic device including the same that can solve the above problems are required.

### DISCLOSURE

### Technical Problem

The embodiment provides a fingerprint sensor substrate and a fingerprint sensor package capable of easily performing an inspection process and having improved reliability.

### Technical Solution

A fingerprint sensor substrate according to an embodiment includes a substrate including a first surface and a second surface opposite to the first surface; a first sensing electrode disposed on the first surface and extending in a first direction; a second sensing electrode disposed on the second surface and extending in a second direction intersecting the first direction; a first wiring electrode connected to the first sensing electrode; and a second wiring electrode connected to the second sensing electrode, wherein the first sensing electrode and the second sensing electrode are disposed on a valid region of the substrate, wherein the first wiring electrode and the second wiring electrode are disposed on a non-valid region of the substrate, wherein the substrate includes a first component mounting region and a second component mounting region, wherein a plurality of pad parts are disposed inside and outside the first component mounting region and the second component mounting region, wherein the pad part includes: a first pad part disposed inside the first component mounting region and connected to the first wiring electrode; a second pad part disposed inside the first component mounting region and connected to the second wiring electrode; a third pad part disposed inside the second component mounting region; and a fifth pad part disposed outside the first component mounting region and the second component mounting region, and wherein a first wiring part and a second wiring part are disposed on at least one surface of the first surface and the second surface, wherein the first wiring part extends from the third pad part to an end of the substrate, wherein the second wiring part includes: a second-first wiring part connecting the third pad part and the fifth pad part; and a second-second wiring part extending from the fifth pad part in an end direction of the substrate, and wherein the second-second wiring part extends from the fifth pad part to the end of the substrate.

### Advantageous Effects

The fingerprint sensor package according to the embodiment includes a sixth pad part. The sixth pad part functions as a test pad.

Electrical characteristics of a third pad part, a fourth pad part, and a fifth pad part can be confirmed by the sixth pad part. In detail, whether the third pad part and the fourth pad part are open or shorted can be confirmed by the sixth pad part.

For example, the wire probe equipment and the sixth pad part are sequentially contacted with a pressure within a set range. Accordingly, an AEI (Auto Electric Inspection) inspection process is performed. Accordingly, whether the third pad part and the fourth pad part are defective can be confirmed.

Therefore, even if sizes of the third pad part and the fourth pad part are small, whether the fingerprint sensor substrate is defective can be confirmed through the sixth pad part. Alternatively, even if an alignment of the third pad parts or the fourth pad parts is misaligned, whether the fingerprint sensor substrate is defective can be confirmed through the sixth pad part.

Therefore, the inspection process of the fingerprint sensor package according to the embodiment becomes easy. In addition, since the fingerprint sensor package is manufactured after the inspection process is performed, the reliability of the fingerprint sensor package is improved.

### DESCRIPTION OF DRAWINGS

FIG. 1 is a drawing for explaining a first surface of a substrate of a fingerprint sensor substrate according to an embodiment.

FIG. 2 is a drawing for explaining a second surface of a substrate of a fingerprint sensor substrate according to an embodiment.

FIG. 3 is a drawing for explaining a first surface of a fingerprint sensor substrate according to an embodiment.

FIG. 4 is a drawing for explaining a second surface of a fingerprint sensor substrate according to an embodiment.

FIG. 5 is a cross-sectional view taken along region A-A′ of FIG. 3.

FIG. 6 is an enlarged view of region A of FIG. 3.

FIG. 7 is an enlarged view of region B of FIG. 3.

FIG. 8 is an enlarged view of region A of FIG. 3 cut along a cutting line.

FIG. 9 is an enlarged view of region B of FIG. 3 cut along a cutting line.

FIG. 10 is another enlarged view of region A of FIG. 3.

FIG. 11 is another enlarged view of region B of FIG. 3.

FIG. 12 is another enlarged view of region A of FIG. 3 cut along a cutting line.

FIG. 13 is another enlarged view of region B of FIG. 3 cut along a cutting line.

FIG. 14 is another enlarged view of region A of FIG. 3.

FIG. 15 is another enlarged view of region B of FIG. 3.

FIG. 16 is another enlarged view of region A of FIG. 3.

FIG. 17 is another enlarged view of region B of FIG. 3.

FIG. 18 is another enlarged view of region A of FIG. 3.

FIG. 19 is another enlarged view of region B of FIG. 3.

FIG. 20 and FIG. 21 are drawings illustrating a fingerprint sensor package according to an embodiment.

FIG. 22 is a top view of a fingerprint sensor package according to another embodiment.

FIG. 23 is an enlarged view of region C of FIG. 1.

FIGS. 24 and 25 are drawings for explaining an inspection process of a wiring electrode in region C of FIG. 1.

FIGS. 26 and 27 are enlarged views of region D of FIG. 22.

FIG. 28 is an enlarged view of region E of FIG. 22.

FIGS. 29 to 32 are drawings of electronic devices including a fingerprint sensor substrate according to an embodiment.

### BEST MODE

Hereinafter, embodiments will be described in detail with reference to the accompanying drawings. However, the spirit and scope of the present invention is not limited to a part of the embodiments described, and may be implemented in various other forms, and within the spirit and scope of the present invention, one or more of the elements of the embodiments may be selectively combined and redisposed.

In addition, unless expressly otherwise defined and described, the terms used in the embodiments of the present invention (including technical and scientific terms) may be construed the same meaning as commonly understood by one of ordinary skill in the art to which this invention belongs, and the terms such as those defined in commonly used dictionaries may be interpreted as having a meaning that is consistent with their meaning in the context of the relevant art. Further, the terms used in the embodiments of the present invention are for describing the embodiments and are not intended to limit the present invention.

In this specification, the singular forms may also include the plural forms unless specifically stated in the phrase, and may include at least one of all combinations that may be combined in A, B, and C when described in “at least one (or more) of A (and), B, and C”.

Further, in describing the elements of the embodiments of the present invention, the terms such as first, second, A, B, (a), and (b) may be used. These terms are only used to distinguish the elements from other elements, and the terms are not limited to the essence, order, or order of the elements.

In addition, when an element is described as being “connected”, “coupled”, or “connected” to another element, it may include not only when the element is directly “connected” to, “coupled” to, or “connected” to other elements, but also when the element is “connected”, “coupled”, or “connected” by another element between the element and other elements.

Further, when described as being formed or disposed “on (over)” or “under (below)” of each element, the “on (over)” or “under (below)” may include not only when two elements are directly connected to each other, but also when one or more other elements are formed or disposed between two elements.

Furthermore, when expressed as “on (over)” or “under (below)”, it may include not only the upper direction but also the lower direction based on one element.

Hereinafter, a fingerprint sensor substrate and a fingerprint sensor package including the same according to an embodiment will be described with reference to the drawings.

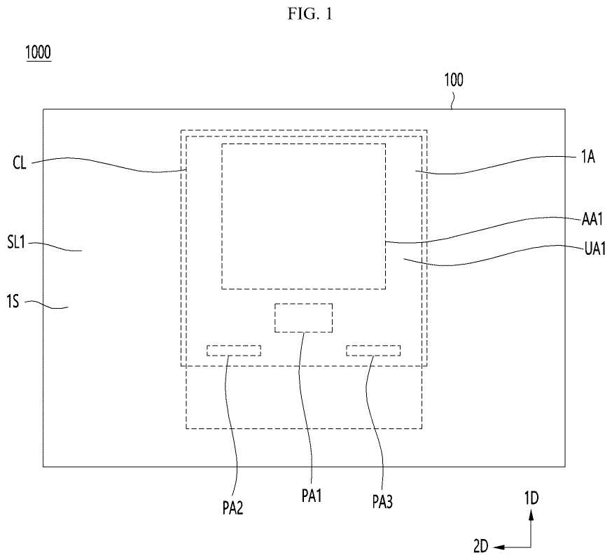

Referring to FIGS. 1 to 4, the fingerprint sensor substrate 1000 includes a substrate 100, a sensing electrode, a wiring electrode, and a pad part.

The substrate 100 includes a flexible material. For example, the substrate 100 may include polyimide (PI). However, the embodiment is not limited thereto. The substrate 100 may include a polymer material such as polyethylene terephthalate (PET) and polyethylene naphthalate (PEN). Accordingly, the fingerprint sensor substrate may be applied to electronic devices having various shapes. For example, the fingerprint sensor substrate may be applied to a wearable electronic device.

The substrate 100 may have a thickness of 20 μm to 100 μm. For example, the substrate 100 may have a thickness of 25 μm to 50 μm. For example, the substrate 100 may have a thickness of 30 μm to 40 μm. If the thickness of the substrate 100 exceeds 100 μm, the overall thickness of the fingerprint sensor substrate may increase. As a result, flexible characteristic of the fingerprint sensor substrate may decrease. In addition, if the thickness of the substrate 100 is less than 20 μm, the reliability of the fingerprint sensor substrate may decrease. For example, when mounting a chip on the fingerprint sensor substrate, the substrate 100 may be damaged by heat and pressure applied to the substrate.

The substrate 100 includes a first surface 1S and a second surface 2S opposite to the first surface 1S.

The sensing electrode is disposed on the first surface 1S and the second surface 2S. In addition, an electronic component is disposed on the first surface 1S or the second surface 2S. For example, the first surface 1S may include a component mounting region. The electronic component is disposed on the component mounting region.

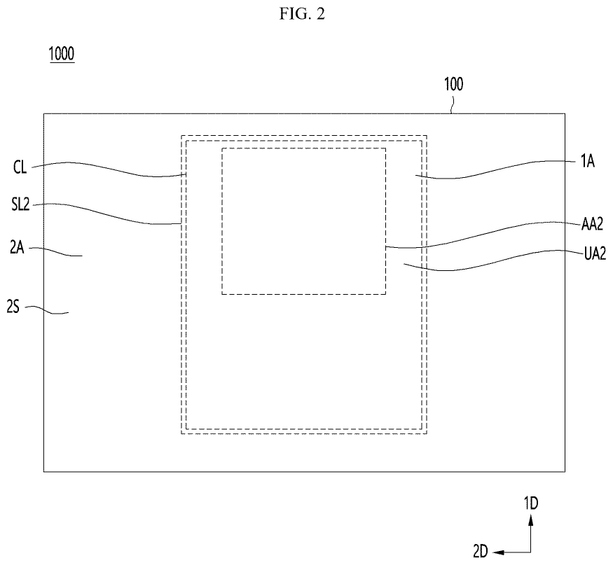

FIG. 1 and FIG. 2 are drawings for explaining the first surface 1S and the second surface 2S of the substrate of the fingerprint sensor substrate 1000.

Referring to FIG. 1 and FIG. 2, the substrate 100 includes a cutting line CL. The fingerprint sensor substrate 1000 is divided into a first region 1A and a second region 2A by the cutting line CL.

The first region 1A is disposed inside the cutting line CL. The second region 2A is disposed outside the cutting line CL. The first region 1A is a region used in the fingerprint sensor substrate 1000. The second region 2A is a region cut after the fingerprint sensor package 2000 is manufactured. That is, the fingerprint sensor substrate 1000 is cut along the cutting line. As a result, the fingerprint sensor package 2000 including the first region 1A is formed, and the second region 2A is removed.

The first region 1A includes a plurality of regions. The first region 1A includes a valid region AA1 and AA2, a non-valid region UA1 and UA2, and a component mounting region. The first surface 1S includes a first valid region AA1 and a first non-valid region UA1. The second surface 2S includes a second valid region AA2 and a second non-valid region UA2.

The valid region AA1 and AA2 is a region where a sensing electrode is disposed. The non-valid region UA1 and UA2 is a region where a wiring electrode is disposed.

The component mounting region may include a plurality of component mounting regions. The plurality of component mounting regions are formed on the first surface 1S. The component mounting region may include a first component mounting region PA1, a second component mounting region PA2, and a third component mounting region PA3.

Electronic components are disposed in each of the component mounting regions. For example, a first electronic component 610 is disposed on the first component mounting region PA1. The first electronic component 610 may include a chip.

A second electronic component 620 and a third electronic component 630 are disposed on the second component mounting region PA2 and the third component mounting region PA3. The second electronic component 620 and the third electronic component 630 may include a multi-layer ceramic condenser (MLCC).

A pad part 400 is disposed on each of the first component mounting region PA1, the second component mounting region PA2, and the third component mounting region PA3. The pad part 400 is electrically connected to components 610, 620, and 630 disposed on the first component mounting region PA1, the second component mounting region PA2, and the third component mounting region PA3.

The substrate 100 includes solder lines SL1 and SL2. The first surface 1S includes a first solder line SL1. The second surface 2S includes a second solder line SL2. The substrate 100 can define a region where a protective layer is disposed by the solder lines SL1 and SL2.

The first solder line SL1 is disposed on a region excluding the first component mounting region PA1, the second component mounting region PA2, and the third component mounting region PA3 on the first valid region 1A. In addition, the second solder line SL2 is disposed on an entire region of the second valid region 2A.

The fingerprint sensor substrate 1000 is defined in a first direction 1D and a second direction 2D. The first direction 1D is a length direction of the fingerprint sensor substrate 1000. The second direction 2D is a width direction of the fingerprint sensor substrate 1000.

The sensing electrode, the wiring electrode, the pad part, and the protective layer are disposed on the first surface 1S and the second surface 2S.

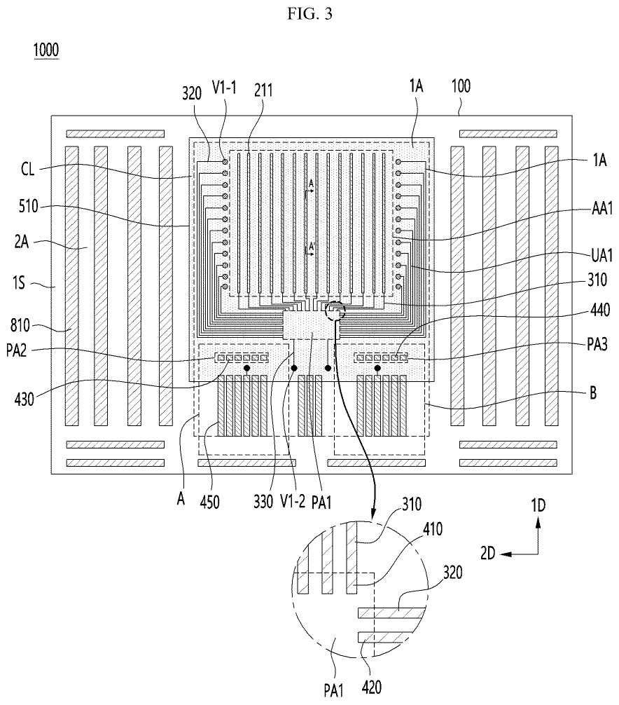

Referring to FIGS. 3 to 5, the sensing electrode includes a first sensing electrode 210 and a second sensing electrode 220. The first sensing electrode 210 is disposed on the first surface 1S. The first sensing electrode 210 is disposed on the first valid region AA1.

The first sensing electrode 210 includes a plurality of first pattern electrodes 211. The first pattern electrode 211 extends in the first direction 1D. The first pattern electrodes 211 are spaced apart in the second direction 2D.

The second sensing electrode 220 is disposed on the second surface 2S. The second sensing electrode 220 is disposed on the second valid region AA2.

The second sensing electrode 220 includes a plurality of second pattern electrodes 221. The second pattern electrodes 221 extend in the second direction 2D. The second pattern electrodes 221 are spaced apart in the first direction 1D.

Accordingly, the first sensing electrode 210 and the second sensing electrode 220 intersect with each other. As a result, an intersection region CA where the first sensing electrode 210 and the second sensing electrode 220 intersect is formed. When a user touches the valid region AA1 and AA2, a change in electrostatic capacitance occurs in the intersection region. As a result, fingerprint information touching the fingerprint sensor substrate is sensed.

The wiring electrode includes a first wiring electrode 310, a second wiring electrode 320, a third wiring electrode 330, and a fourth wiring electrode 340. The first wiring electrode 310 is disposed on the first non-valid region UA1. The first wiring electrode 310 is connected to the first sensing electrode 210 and the first pad part 410. One end of the first wiring electrode 310 is connected to the first sensing electrode 210. Another end of the first wiring electrode 310 is connected to the first pad part 410.

The second wiring electrode 320 is disposed on the first non-valid region UA1. The second wiring electrode 320 is connected to the second sensing electrode 220 and the second pad part 420. One end of the second wiring electrode 320 is connected to the second sensing electrode 220. Another end of the second wiring electrode 320 is connected to the second pad part 420. In detail, the fingerprint sensor substrate 1000 includes a plurality of vias. One end of the second wiring electrode 320 is connected to the second sensing electrode through the via V1-1. In addition, another end of the second wiring electrode 320 is connected to the second pad part 420 on the first surface 1S.

The third wiring electrode 330 is disposed on the first non-valid region UA1. The third wiring electrode 330 is disposed on the first surface 1S. The third wiring electrode 330 can be connected to the first pad part 410 and the fifth pad part 450. Alternatively, the third wiring electrode 330 may be connected to the second pad part 420 and the fifth pad part 450. In detail, one end of the third wiring electrode 330 is connected to the first pad part 410 or the second pad part 420. In addition, another end of the third wiring electrode 330 is connected to the fifth pad part 450.

The fourth wiring electrode 340 is disposed on the second non-valid region UA1. The fourth wiring electrode 340 is disposed on the second surface 2S. The third wiring electrode 330 and the fourth wiring electrode 340 are connected through a via. In detail, the third wiring electrode 330 and the fourth wiring electrode 340 are electrically connected through a first-second via V1-2.

At least one of the first sensing electrode 210, the second sensing electrode 220, the first wiring electrode 310, the second wiring electrode 320, the third wiring electrode 330, and the fourth wiring electrode 340 may include a metal material having excellent electrical conductivity. In detail, at least one of the first sensing electrode 210, the second sensing electrode 220, the first wiring electrode 310, the second wiring electrode 320, the third wiring electrode 330, and the fourth wiring electrode 340 may include copper (Cu). However, the embodiment is not limited thereto. At least one of the first sensing electrode 210, the second sensing electrode 220, the first wiring electrode 310, the second wiring electrode 320, the third wiring electrode 330, and the fourth wiring electrode 340 may include at least one metal selected from the group consisting of copper (Cu), aluminum (Al), chromium (Cr), nickel (Ni), silver (Ag), molybdenum (Mo), gold (Au), titanium (Ti), and alloys thereof.

In addition, the sensing electrode 210 and 220 and the wiring electrode 310 and 320 may include a same material. For example, the sensing electrode 210 and 220 and the wiring electrode 310 and 320 may be formed integrally.

The pad part may include a plurality of pad parts. The pad part 400 may include a first pad part 410, a second pad part 420, a third pad part 430, a fourth pad part 440, and a fifth pad part 450.

The first pad part 410 and the second pad part 420 are disposed on the first surface 1S. The first pad part 410 and the second pad part 420 are disposed inside the first component mounting region PA1.

The first pad part 410 and the second pad part 420 are connected to a first electronic component 610 disposed on the first component mounting region PA1. Accordingly, fingerprint information sensed in the valid region AA1 and AA2 is transmitted to the chip.

The third pad part 430 is disposed inside the second component mounting region PA2. In addition, the fourth pad part 440 is disposed inside the third component mounting region PA3.

The third pad part 430 is connected to the first electronic component 610 disposed on the first component mounting region PA1 and the second electronic component 620 disposed on the second component mounting region PA2. In addition, the fourth pad part 440 is connected to the first electronic component 610 disposed on the first component mounting region PA1 and the third electronic component 630 disposed on the third component mounting region PA3.

The fifth pad part 450 is disposed on the first surface 1S. The fifth pad part 450 is disposed on the first non-valid region UA1. The fifth pad part 450 is connected to an external power component.

The third pad part 430 and the fourth pad part 440 are connected to the fifth pad part 450. In detail, at least one third pad part can be connected to the fifth pad part 450. In addition, at least one fourth pad part 440 can be connected to the fifth pad part 450.

Accordingly, the power supplied from the power component is transmitted to the second component mounting region PA3 and the third component mounting region PA3. In addition, the power supplied from the power component is transmitted to the first electronic component 610 through the third wiring electrode 330 and the fourth wiring electrode 340.

The protective layer includes a first protective layer 510 and a second protective layer 520. The first protective layer 510 is disposed on the first surface 1S. The first protective layer 510 is disposed inside the first solder line SL1. The first protective layer 510 is disposed on the first region 1A of the first surface 1S excluding the first component mounting region 610, the second component mounting region PA2, the third component mounting region PA3, and the fifth pad part 450.

The second protective layer 520 is disposed on the second surface 2S. The second protective layer 520 is disposed inside the second solder line SL2. The second protective layer 520 may be disposed on an entire surface of the first region 1A of the second surface 2S.

The protective layer 510 and 520 may include a solder paste. For example, the solder paste may include a thermosetting resin, a thermoplastic resin, a filler, a curing agent, or a curing accelerator.

The fingerprint sensor substrate 1000 may further include a dummy pattern. In detail, the dummy pattern may be disposed on the first surface 1S and the second surface 2S. For example, a first dummy pattern 810 may be disposed on the first surface 1S. The first dummy pattern 810 may be disposed on the second region 2A.

A second dummy pattern 820 may be disposed on the second surface 2S. The second dummy pattern 820 may be disposed on at least one region among the first region 1A and the second region 2A.

A warpage of the fingerprint sensor substrate 1000 may be reduced by the dummy patterns 810 and 820. In detail, the warpage of the fingerprint sensor substrate 1000 in one direction may be reduced by the dummy patterns 810 and 820.

The fingerprint sensor substrate 1000 undergoes an inspection process. Specifically, a sensing electrode, a wiring electrode, a pad part, and a protective layer are formed on the substrate. Then, an inspection process is performed using an AEI (Auto Electric Inspection) process. Whether the fingerprint sensor substrate 1000 is powered is checked through the inspection process. The AEI (Auto Electric Inspection) process is performed by contacting the wire probe equipment with the pad part.

Sizes of the third pad part 430 and the fourth pad part 440 are small. In addition, Positions of the third pad part 430 and the fourth pad part 440 are not aligned. Accordingly, the AEI (Auto Electric Inspection) process may be difficult.

Accordingly, the fingerprint sensor substrate 1000 includes an additional pad part connected to at least one pad part among the third pad part 430, the fourth pad part 440, and the fifth pad part 450.

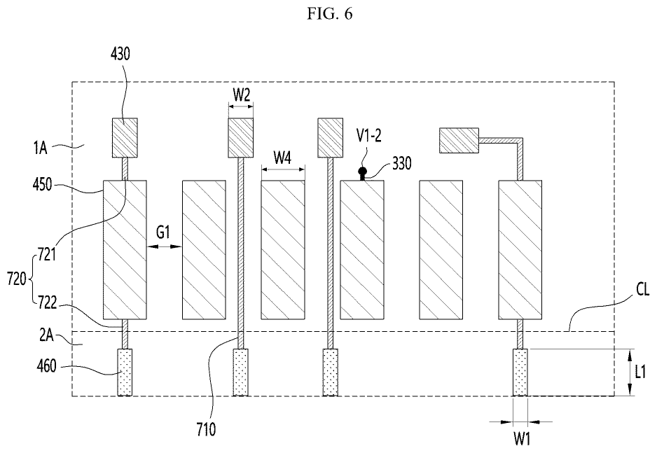

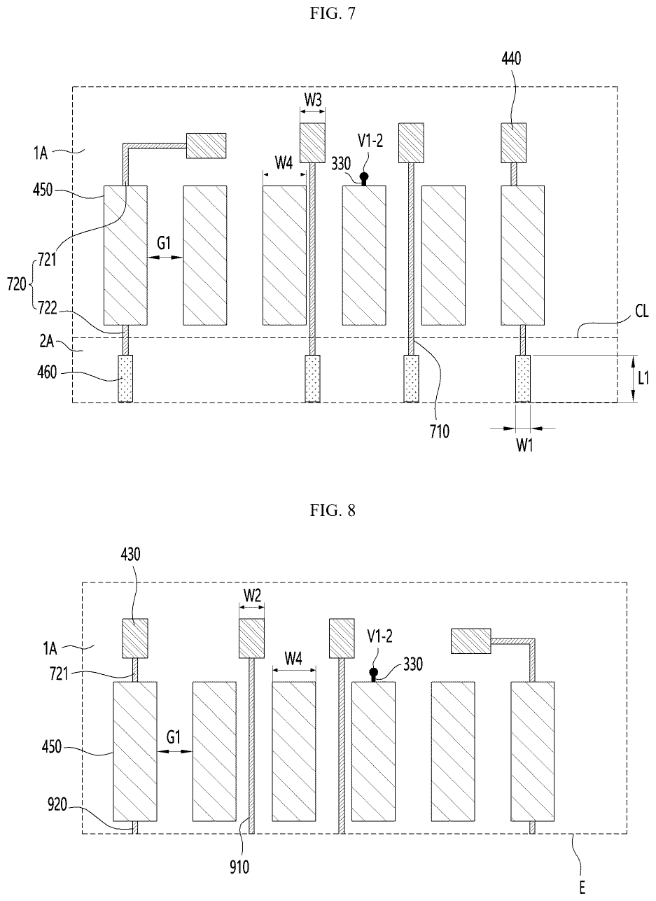

FIG. 6 and FIG. 7 are enlarged views of regions A and B of FIG. 3, respectively.

Referring to FIG. 3, FIG. 6 and FIG. 7, the fingerprint sensor substrate 1000 includes a sixth pad part 460. The sixth pad part 460 is disposed on at least one of the first surface 1S and the second surface 2S.

The sixth pad part 460 is disposed on the second region 2A. The sixth pad part 460 can be connected to at least one of the third pad part 430, the fourth pad part 440 and the fifth pad part 450.

Referring to FIG. 6, the sixth pad part 460 is connected to the third pad part 430 and the fifth pad part 450. For example, the third pad part 430 includes a plurality of third pad parts. The third pad part 430 that is not connected to the fifth pad part 450 is directly connected to the sixth pad part 460 by the first wiring part 710. In addition, the third pad part 430 that is connected to the fifth pad part 450 is connected to the sixth pad part 460 by the second wiring part 720 and the fifth pad part 450. In detail, the third pad part 430 is connected to the fifth pad part 450 by the second-first wiring part 721. In addition, the fifth pad part 450 is connected to the sixth pad part 460 by the second-second wiring part 722.

The first wiring part 710 and the second wiring part 720 may have a line width of 5 μm to 15 μm.

Referring to FIG. 7, the sixth pad part 460 is connected to the fourth pad part 440 and the fifth pad part 450. For example, the fourth pad part 440 includes a plurality of fourth pad parts. The fourth pad part 440 that is not connected to the fifth pad part 450 is directly connected to the sixth pad part 460 through the first wiring part 710. In addition, the fourth pad part 430 that is connected to the fifth pad part 450 among the plurality of fourth pad parts 440 is connected to the sixth pad part 460 through the second wiring part 720 and the fifth pad part 450. In detail, the fourth pad part 440 is connected to the fifth pad part 450 through the second-first wiring part 721. In addition, the fifth pad part 450 is connected to the sixth pad part 460 by the second-second wiring part 722.

The first wiring part 710 and the second wiring part 720 have a line width of 5 μm to 15 μm.

Therefore, a plurality of sixth pad parts 460 spaced apart from each other are disposed on the second region 2A.

The electrical characteristics of the third pad part 430 and the fourth pad part 440 can be confirmed by the sixth pad part 460. That is, the sixth pad part 460 is a test pad. In detail, the open and short of the third pad part 430 and the fourth pad part 440 can be confirmed by the sixth pad part 460. For example, the wire probe equipment contacts the sixth pad part at a pressure within a set range. By this, the AEI (Auto Electric Inspection) process is performed. Accordingly, it is possible to check whether the third pad part 430 and the fourth pad part 440 are defective.

To this end, the sixth pad part 460 has a length and width within a set range. In detail, a length L of the sixth pad part 460 may be 400 μm or more. More specifically, the length L of the sixth pad part 460 may be 400 μm to 1000 μm, 400 μm to 800 μm, or 400 μm to 600 μm.

If the length L of the sixth pad part is less than 400 μm, a size difference occurs between the wire probe equipment and the sixth pad part. This makes the inspection process difficult. In addition, if the length L of the sixth pad part exceeds 1000 μm, the length of the sixth pad part 460 increases unnecessarily. By this, an area of the fingerprint sensor substrate increases. In addition, a process efficiency decreases.

A width W1 of the sixth pad part may be different from a width W2 of the third pad part, a width W3 of the fourth pad part, and a width W4 of the fifth pad part. In detail, the width W1 of the sixth pad part may be smaller than at least one of the width W2 of the third pad part and the width W3 of the fourth pad part. For example, the width W1 of the sixth pad part may be 3% or more of the width of at least one of the width W2 of the third pad part and the width W3 of the fourth pad part. In detail, the width W1 of the sixth pad part may be 3% to 10%, 3.5% to 8%, or 5% to 7% of the width of at least one of the width W2 of the third pad part and the width W3 of the fourth pad part.

If the width W1 of the sixth pad part is less than 3% of at least one of the widths W2 of the third pad part and W3 of the fourth pad part, a contact time between the wire probe and the sixth pad part 460 is shortened. As a result, the accuracy of the inspection process is reduced.

If the width W1 of the sixth pad part is more than 10% of at least one of the widths W2 of the third pad part and W3 of the fourth pad part, a process time for forming the sixth pad part increases. In addition, an area of the second region increases in order to form the sixth pad part. Accordingly, an area of the fingerprint sensor substrate increases.

In addition, the width W1 of the sixth pad part may be smaller than the width W4 of the fifth pad part. For example, the width W1 of the sixth pad part may be 1% or more of the width W4 of the fifth pad part. In detail, the width W1 of the sixth pad part may be 1% to 8%, 2% to 6%, or 3% to 5% of the width W4 of the fifth pad part.

If the width W1 of the sixth pad part is less than 1% of the width W4 of the fifth pad part, a contact time between the wire probe and the sixth pad part 460 is shortened. Accordingly, the accuracy of the inspection process is reduced.

If the width W1 of the sixth pad part exceeds 8% of the width W4 of the fifth pad part, a process time for forming the sixth pad part increases. In addition, an area of the second region increases to form the sixth pad part. Accordingly, an area of the fingerprint sensor substrate increases.

In addition, the width W1 of the sixth pad part may be different from a gap G1 of the fifth pad part. In detail, the width W1 of the sixth pad part may be smaller than the gap G1 of the fifth pad part. For example, the width W1 of the sixth pad part may be 3% or more of the gap G1 of the fifth pad part. In detail, the width W1 of the sixth pad part may be 3% to 10%, 3.5% to 8%, or 5% to 7% of the gap G1 of the fifth pad part.

If the width W1 of the sixth pad part is less than 3% of the gap G1 of the fifth pad part, a contact time between the wire probe and the sixth pad part 460 is shortened. As a result, the accuracy of the inspection process is reduced.

If the width W1 of the sixth pad part exceeds 10% of the gap G1 of the fifth pad part, a process time for forming the sixth pad part increases. In addition, an area of the second region increases to form the sixth pad part. Accordingly, an area of the fingerprint sensor substrate increases.

For example, the width W1 of the sixth pad part may be 12 μm or more. In addition, the width W1 of the sixth pad part satisfies a relationship with the widths of the third pad part 430, the fourth pad part 440, and the fifth pad part 450.

An AEI (Auto Electric Inspection) process is performed by the sixth pad part 460. Then, the fingerprint sensor substrate 1000 is cut along the cutting line CL. Accordingly, the fingerprint sensor package 2000 is manufactured.

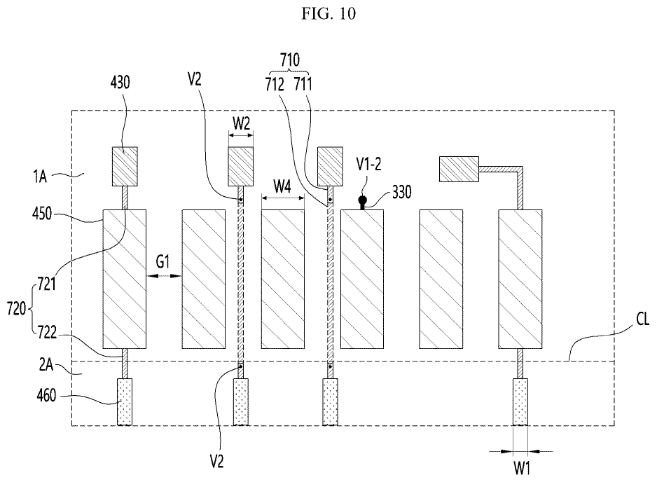

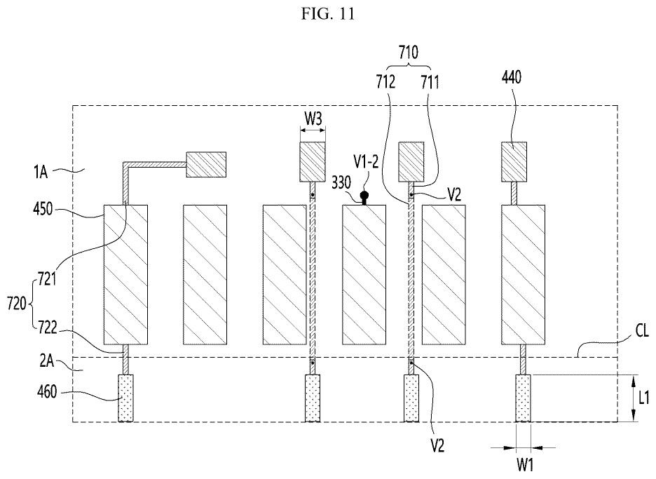

FIGS. 10 and 11 are different enlarged views of A and B regions of FIG. 3, respectively.

Referring to FIG. 3, FIG. 10, and FIG. 11, at least one of the first wiring part 710 and the second wiring part 720 is disposed on at least one surface of the first surface 1S and the second surface 2S.

The first wiring part 710 is disposed on at least one surface of the first surface 1S and the second surface 2S. For example, the first wiring part 710 may be disposed on the first surface 1S and the second surface 2S.

The first wiring part 710 may include a first-first wiring part 711 and a first-second wiring part 712. The first-first wiring part 711 is disposed on the first surface 1S. The first-second wiring part 712 is disposed on the second surface 2S. The first-first wiring part 711 and the first-second wiring part 712 are connected. In detail, the first-first wiring part 711 and the first-second wiring part 712 are connected through a via V2.

The third pad part 430 and the fourth pad part 440 are directly connected to the sixth pad part 460 by the first wiring part 710. Accordingly, the first wiring part 710 is disposed between the fifth pad part 450. Accordingly, the first wiring part 710 and the fifth pad part 450 may be short-circuited during a process of forming the first wiring part 710.

Therefore, a fingerprint sensor substrate according to another embodiment arranges the first wiring part 710 on both the first surface 1S and the second surface 2S. Accordingly, the above problem can be solved. In detail, the first wiring part can be disposed between the fifth pad part on the second surface 2S. Therefore, a short circuit between the first wiring part and the fifth pad part can be prevented. Therefore, the reliability of the fingerprint sensor substrate is improved.

A length of the first-first wiring part 711 can be different from a length of the first-second wiring part 712. For example, the length of the first-second wiring part 712 can be longer than the length of the first-first wiring part 711. That is, the length of the first wiring part 710 disposed on the second surface 2S can be longer than the length of the first wiring part 710 disposed on the first surface 1S.

For example, the length of the first-first wiring part 711 can be less than or equal to a distance between the fifth pad part 450 and the third pad part 430. Alternatively, the length of the first-first wiring part 711 may be less than or equal to a distance between the fifth pad part 450 and the fourth pad part 440. In addition, the length of the first-second wiring part 712 may be greater than or equal to a length of the fifth pad part 450.

The AEI (Auto Electric Inspection) process is performed by the sixth pad part 460. Then, the fingerprint sensor substrate 1000 is cut along the cutting line CL. Accordingly, the fingerprint sensor package 2000 is manufactured.

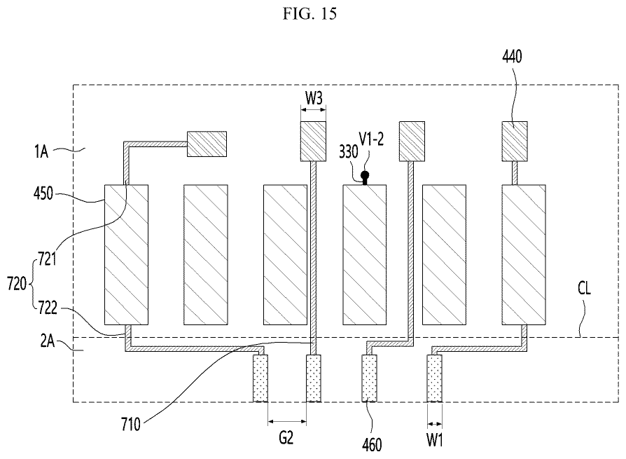

FIG. 14 and FIG. 15 are another enlarged views of regions A and B of FIG. 3.

Referring to FIG. 3, FIG. 14 and FIG. 15, gaps of the sixth pad part 460 may be same or similar.

Referring to FIG. 14, a gap G2 of the sixth pad part 460 is less than or equal to a width W1 of the sixth pad part 460. For example, the gap G2 of the sixth pad part 460 may be 80% or more, 90% or more, 95% or more, or 99% or more of the width W1 of the sixth pad part 460. If the gap G2 of the sixth pad part 460 is less than 80% of the width W1 of the sixth pad part 460, a gap between the sixth pad parts 460 becomes smaller. Accordingly, the accuracy of the inspection process is reduced. In detail, the wire probe equipment may interfere with the adjacent sixth pad part. Therefore, the accuracy of the inspection process may be reduced.

Alternatively, referring to FIG. 15, a gap G2 of the sixth pad part 460 may exceed the width W1 of the sixth pad part 460. For example, the gap G2 of the sixth pad part 460 may be 120% or less, 115% or less, 110% or less, or 105% or less of the width W1 of the sixth pad part 460. If the gap G2 of the sixth pad part 460 exceeds 120% of the width W1 of the sixth pad part 460, a gap between the sixth pad parts 460 increases. Accordingly, an area on which the sixth pad part 460 is disposed increases. Accordingly, an area of the second region 2A increases. Accordingly, a size of the fingerprint sensor substrate increases.

The gap G2 of the sixth pad part 460 may have a size within a set range. For example, the gap G2 of the sixth pad part 460 may be 12 μm or more. That is, the gap G2 of the sixth pad part 460 is 12 μm or more and satisfies a relationship with the width of the sixth pad part 460.

A gap of the sixth pad parts 460 may be the same or similar. For example, a deviation of the gaps G2 of the sixth pad part 460 may be 10% or less, 7% or less, 5% or less, or 3% or less of the width W1 of the sixth pad part 460. If the deviation of the gaps G2 of the sixth pad part 460 exceeds 10% of the width W1 of the sixth pad part, the gaps of the sixth pad parts becomes uneven, thereby reducing the accuracy of the inspection process.

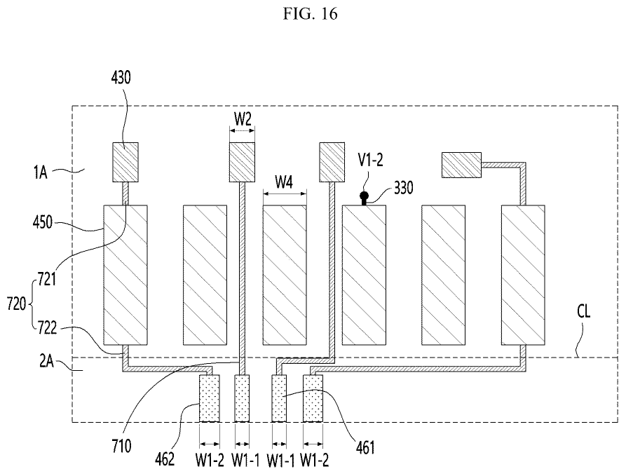

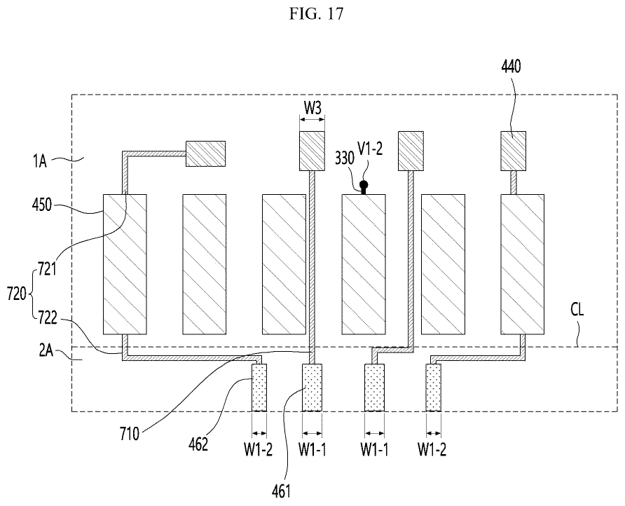

FIG. 16 and FIG. 17 are another enlarged views of regions A and B of FIG. 3.

Referring to FIG. 3, FIG. 16 and FIG. 17, the sixth pad part 460 includes pad parts having different sizes.

Referring to FIG. 16 and FIG. 17, the sixth pad part includes a sixth-first pad part 461 and a sixth-second pad part 462. The sixth-first pad part 461 is a pad part connected to the third pad part 430 and the fourth pad part 440. In detail, the sixth-first pad part 461 is a pad part connected to the third pad part 430 and the fourth pad part 440 through the first wiring part 710. In addition, the sixth-second pad part 462 is a pad part connected to the third pad part 430, the fourth pad part 440, and the fifth pad part 450. In detail, the sixth-second pad part 462 is a pad part connected to the third pad part 430, the fourth pad part 440, and the fifth pad part 450 through the second wiring part 720.

A width W1-1 of the sixth-first pad part and a width W1-2 of the sixth-second pad part may be different from each other. Referring to FIG. 16, the width W1-1 of the sixth-first pad part may be smaller than the width W1-2 of the sixth-second pad part. Alternatively, referring to FIG. 17, the width W1-1 of the sixth-first pad part may be larger than the width W1-2 of the sixth-second pad part. Accordingly, the sixth pad part 460 can be formed in different sizes depending on the number or type of pad parts to which it is connected.

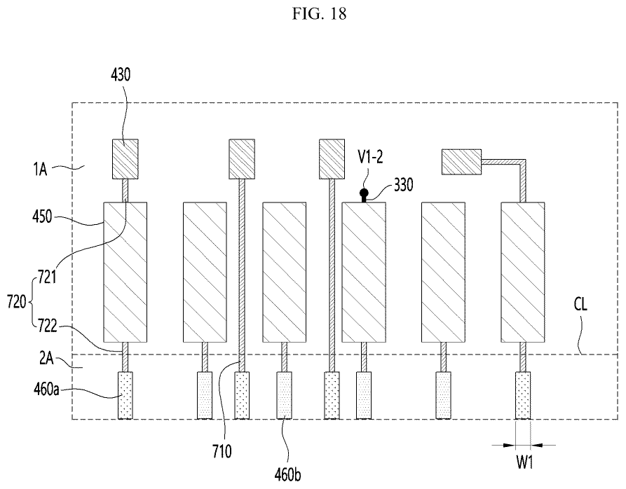

Therefore, when the inspection process is performed, it is easy to check which pad part the pad part with which a defective pad part is connected. In detail, since a size of the sixth pad part is formed differently depending on the number or type of pad parts connected to the sixth pad part, it is easy to check which pad part the sixth pad part with which a defective pad part is connected. FIG. 18 and FIG. 19 are another enlarged views of regions A and B of FIG. 3.

Referring to FIG. 3, FIG. 18 and FIG. 19, the sixth pad part 460 can include a pad part that is connected only to the fifth pad part 450.

The sixth pad part may include a sixth pad part 460a connected to at least one pad part among the third pad part 430, the fourth pad part 440, and the fifth pad part 450, and a pad part 460b connected only to the fifth pad part 450.

Therefore, the fifth pad part 460 may all be connected to the sixth pad part 460. Accordingly, the AEI inspection process is simplified. In detail, it is possible to check whether the fingerprint sensor substrate is defective by only one inspection process of contacting the wire probe equipment and the sixth pad part.

Referring to FIGS. 8, 9, 12, and 13, the fingerprint sensor package 2000 includes a first dummy part 910 and a second dummy part 920. The first dummy part 910 and the second dummy part 920 are formed by the first wiring part 710 and the second wiring part 720 remaining on the first region 1A.

In detail, the first dummy part 910 is formed by remaining the first wiring part 710. That is, the first dummy part 910 may be the first wiring part 710. In addition, the second dummy part 920 is formed by remaining the second-second wiring part 722. That is, the second dummy part 920 may be the second-second wiring part 722.

The first dummy part 910 and the second dummy part 920 do not transmit current. In addition, the first dummy part 910 and the second dummy part 920 do not receive current.

A width of at least one dummy part among the first dummy part 910 and the second dummy part 920 may be 5 μm to 15 μm.

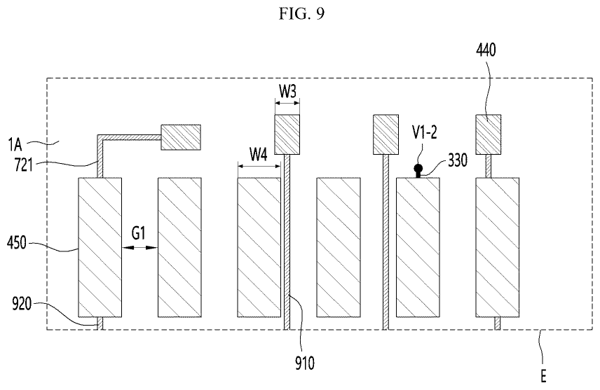

Referring to FIGS. 8 and 9, the first dummy part 910 and the second dummy part 920 are disposed on the first surface 1S.

The first dummy part 910 extends from the third pad part 430 to an end E of the substrate. The first dummy part 910 is disposed in a region between the adjacent fifth pad parts 450.

In addition, the second dummy part 920 extends from the fifth pad part 450 toward the end E of the substrate. The second dummy part 920 extends from the fifth pad part 450 to the end E of the substrate. The second dummy part 920 is disposed in a region between the fifth pad part 450 and the end of the substrate.

A length of the first dummy part 910 and a length of the second dummy part 920 are different. In detail, the length of the first dummy part 910 is longer than the length of the second dummy part 920.

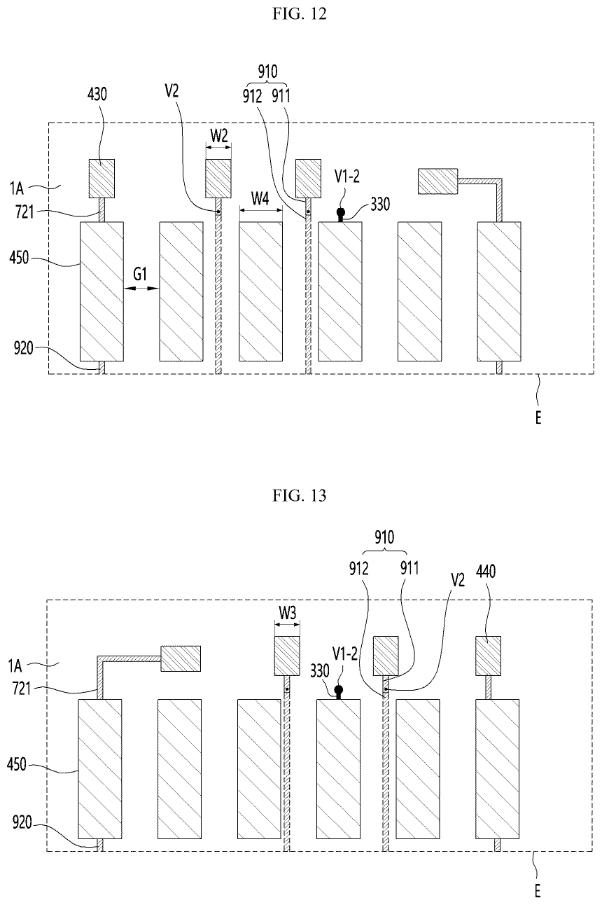

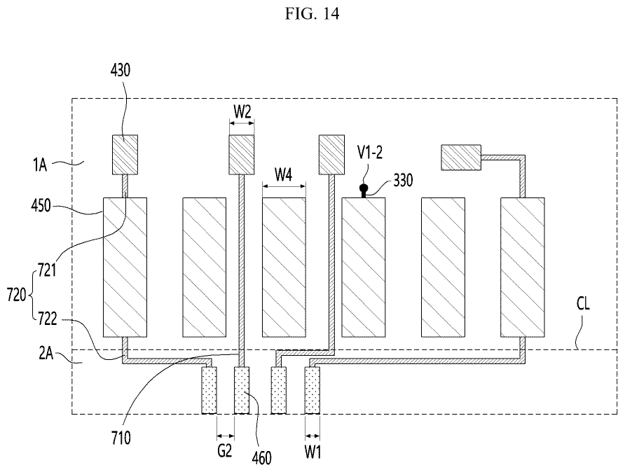

Referring to FIGS. 12 and 13, the first dummy part 910 and the second dummy part 920 are disposed on at least one of the first surface 1S and the second surface 2S. In detail, the first dummy part 910 is disposed on the first surface 1S and the second surface 2S. The first dummy part 910 includes a first-first dummy part 911 disposed on the first surface 1S and a first-second dummy part 912 disposed on the second surface 2S. The first-first dummy part 911 and the first-second dummy part 912 are connected through the second via V2.

The first dummy part 910 is formed by remaining the first wiring part 710. In detail, the first dummy part 910 is formed by remaining the first-first wiring part 711 and the first-second wiring part 712. The first dummy part 910 includes the first-first dummy part 911 and the first-second dummy part 912. The first-first dummy part 911 is formed by remaining the first-first wiring part 711. That is, the first-first dummy part 911 may be the first-first wiring part 711. The first-second dummy part 912 is formed by remaining the first-second wiring part 712. That is, the first-second dummy part 912 may be the first-second wiring part 712.

In addition, the second dummy part 920 is formed by remaining the second-second wiring part 722. That is, the second dummy part 920 may be the second-second wiring part 722.

In addition, the second dummy part 920 is disposed on the first surface 1S.

The first dummy part 910 extends from the third pad part 430 to the end E of the substrate. In detail, the first-first dummy part 911 is disposed in a region between the third pad part 430 and the fifth pad part 450 on the first surface 1S. In addition, the first-second dummy part 912 is disposed on the second surface 2S in a region corresponding to a region between the adjacent fifth pad part 450.

In addition, the second dummy part 920 extends from the fifth pad part 450 to the end E of the substrate. The second dummy part 920 is disposed in a region between the fifth pad part 450 and the end of the substrate.

The lengths of the first dummy part 910 and the second dummy part 920 are different. In detail, the length of the first dummy part 910 is longer than the length of the second dummy part 920. In addition, the length of the first-second dummy part 912 is longer than the length of the first-first dummy part 911. In addition, the length of the first-second dummy part 912 is longer than the length of the second dummy part 920.

The first dummy part 910 and the second dummy part 920 serve as dummy patterns in the fingerprint sensor package 2000.

When the fingerprint sensor substrate 1000 is cut, the dummy patterns 810 and 820 disposed on the second region 2A are removed. Accordingly, a dummy pattern area of the fingerprint sensor package 2000 is reduced.

Since the first dummy part 910 and the second dummy part 920 serve as dummy patterns, the strength of the fingerprint sensor package can be improved. In addition, the warpage of the fingerprint sensor package can be reduced.

In addition, the first dummy part 910 and the second dummy part 920 are disposed on both the first surface 1S and the second surface 2S. Accordingly, the warpage of the fingerprint sensor package is reduced.

In addition, the first dummy part 910 and the second dummy part 910 are formed by cutting the cutting line CL. Accordingly, a separate process for forming the first dummy part 910 and the second dummy part 910 is not required, and thus, the process efficiency is improved.

In addition, the first dummy part 910 and the second dummy part 920 are disposed on both the first surface 1S and the second surface 2S. Accordingly, the warpage of the fingerprint sensor package is reduced.

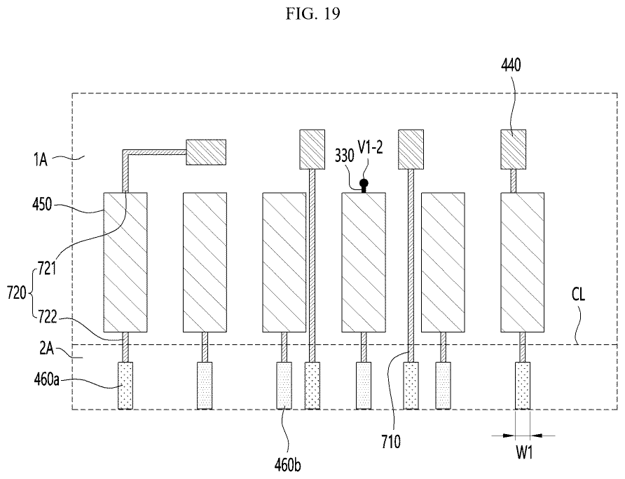

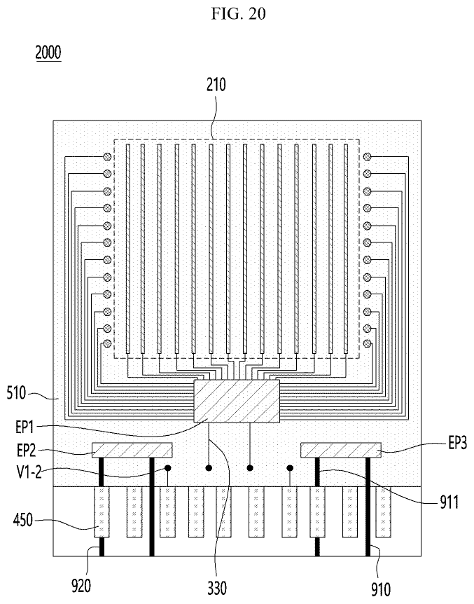

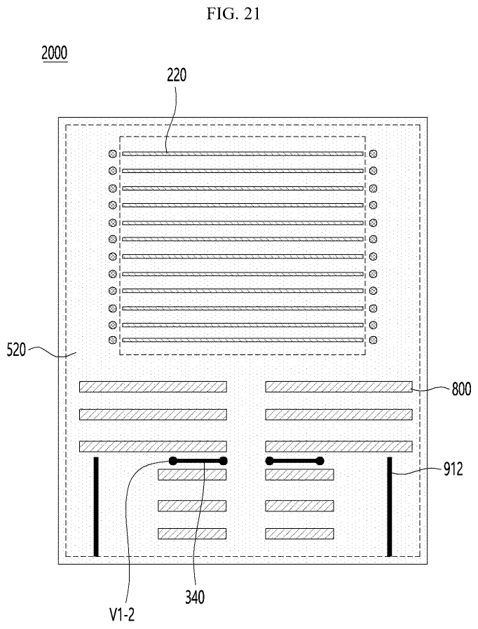

Hereinafter, a fingerprint sensor package including the fingerprint sensor substrate described above will be described with reference to FIGS. 20 and 21.

FIG. 20 is a drawing illustrating a first surface of a fingerprint sensor package. FIG. 21 is a drawing illustrating a second surface of a fingerprint sensor package.

The fingerprint sensor package may be formed by cutting along a cutting line CL of the fingerprint sensor substrate.

Referring to FIGS. 20 and 21, the fingerprint sensor package may include the fingerprint sensor substrate and a plurality of electronic components disposed on the fingerprint sensor substrate.

In detail, an electronic component may be disposed on at least one region among the first component mounting region, the second component mounting region, and the third component mounting region. For example, a first electronic component EP1 may be disposed on the first component mounting region. The first electronic component EP1 may include a fingerprint sensor chip. In addition, an MLCC may be disposed on at least one region among the second component mounting region and the third component mounting region.

In addition, the first dummy part 910 and the second dummy part 920 may be disposed on the first surface 1S or the second surface 2S.

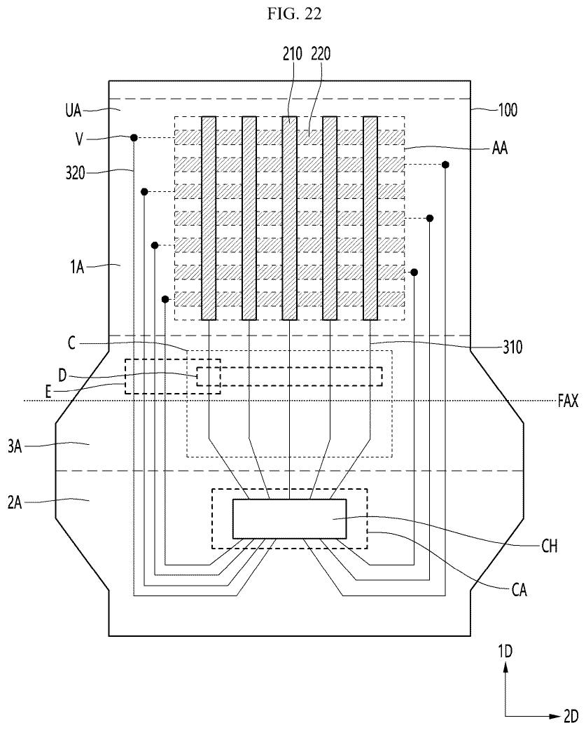

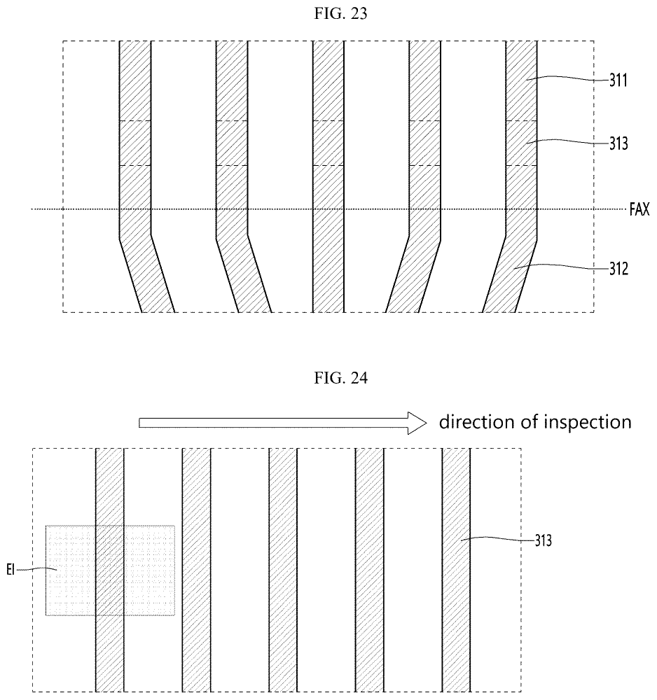

Hereinafter, a fingerprint sensor package according to another embodiment will be described with reference to FIGS. 22 to 28.

The fingerprint sensor package according to another embodiment is applied to a smart IC card.

Referring to FIG. 22, the fingerprint sensor package according to another embodiment includes a substrate 100, a sensing electrode 210 and 220, a wiring electrode 310 and 320, and a chip CH.

The material and thickness of the substrate 100 are the same as those in the previously described embodiment.

The substrate 100 is divided into a plurality of regions. For example, the substrate 100 includes a first region 1A, a second region 2A, and a third region 3A. The first region 1A is a region where the sensing electrodes 210 and 220 are disposed. In addition, the second region 2A is a region where the chip CH is disposed. In addition, the third region 3A is a region between the first region 1A and the second region 2A.

The substrate 100 can be bent in one direction. In detail, the substrate 100 is bent in one direction by a folding axis FAX on the third region 3A.

The substrate 100 may include a valid region AA, a non-valid region UA, and a chip mounting region CA. The valid region AA is a region where a fingerprint is sensed. In addition, the non-valid region UA is a region where a wiring electrode is disposed. In addition, the chip mounting region CA is a region where the chip CH is disposed.

The sensing electrodes 210 and 220 are disposed on the valid region AA. The material of the sensing electrodes 210 and 220 is the same as the previously described embodiment.

The sensing electrodes include a first sensing electrode 210 extending in the first direction 1D and a second sensing electrode 220 extending in the second direction 2D. The first sensing electrode 210 and the second sensing electrode 220 intersect. Accordingly, a fingerprint can be sensed in a capacitive manner.

The first sensing electrode 210 and the second sensing electrode 220 may be disposed on opposite surfaces of the substrate 100. Alternatively, the first sensing electrode 210 and the second sensing electrode 220 may be disposed on a same surface of the substrate 100.

In FIG. 22, the first sensing electrode 210 and the second sensing electrode 220 are shown to be disposed to extend in an intersecting direction. However, the embodiment is not limited thereto. That is, the first sensing electrode 210 and the second sensing electrode 220 may not intersect or may extend in a same direction depending on the fingerprint sensing method.

The wiring electrode 310 and 320 is disposed on the non-valid region UA. The wiring electrode 310 and 320 is electrically connected to the sensing electrode 210 and 220 and the chip CH. For example, the wiring electrode includes the first wiring electrode 310 and the second wiring electrode 320. The first wiring electrode 310 is connected to the first sensing electrode 210 and the chip CH. The second wiring electrode 320 is connected to the second sensing electrode 220 and the chip CH. The second wiring electrode 320 is connected to the second sensing electrode 220 on another surface of the substrate. In addition, the second wiring electrode 320 is extended to one surface of the substrate through a via V and connected to the chip CH.

The inspection process may be performed in one region of the wiring electrode. In detail, the inspection process is performed in the inspection region of the wiring electrode.

Referring to FIG. 2, the first wiring electrode 310 is divided into a first wiring part 311, a second wiring part 312, and a third wiring part 313 according to a position. The first wiring part 311 is connected to the first sensing electrode 210. The second wiring part 312 is connected to the chip CH. The first wiring part 311 is disposed between the first region 1A and the folding axis FAX. In addition, the second wiring part 312 is disposed between the second region 3A and the folding axis FAX.

The third wiring part 313 is disposed between the first wiring part 311 and the second wiring part 312. The third wiring part 313 is an inspection region of the wiring electrode.

The third wiring part 313 is formed by controlling the order of a formation process of the protective layer.

In detail, a protective layer is disposed on the first wiring electrode 310 except for the pad part. For example, the protective layer is not disposed on a region except for the pad part and the third wiring part. After the inspection process is completed, the protective layer is disposed on the third wiring part.

Alternatively, a region of the third wiring part is set. Then, the inspection process is performed on the third wiring part. Next, a protective layer is disposed on the first wiring electrode 310 except for the pad part.

Accordingly, the fingerprint sensor package does not require a separate test pad for the inspection process. In detail, some regions of the wiring electrodes are set as inspection regions. The electrical characteristics of the fingerprint sensor package are checked through the inspection region. Next, a protective layer is disposed on the wiring electrodes. Therefore, the wiring electrodes are used as test pads. Therefore, a separate test pad is not required.

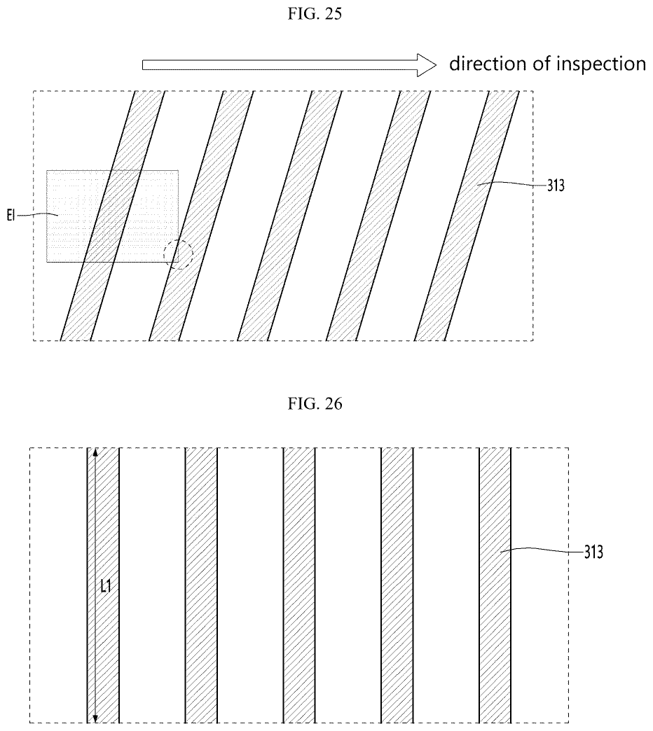

Referring to FIGS. 24 and 25, the inspection process is performed with an inspection device including a wire probe. In detail, the inspection device checks the electrical characteristics of each wiring electrode while moving in a direction in which the wiring electrodes are adjacent. In detail, the inspection device (EI) checks the electrical characteristics of each wiring electrode while moving in the second direction.

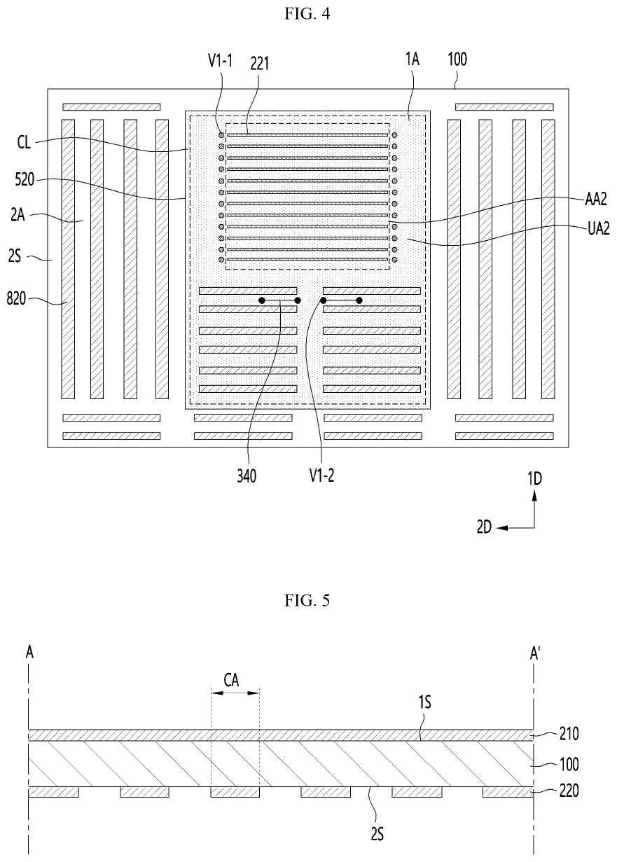

As shown in FIG. 4, when the inspection device (EI) moves, the inspection device may interfere with the adjacent wiring. Accordingly, the inspection accuracy of the wiring electrode may decrease. In detail, when the wiring electrode is tilted, the inspection equipment may come into contact with the adjacent wiring electrode and interfere with each other. As a result, the wiring electrode cannot be easily inspected through the inspection equipment.

Accordingly, a fingerprint sensor package according to another embodiment solves the above problem by controlling a tilting angle of the wiring electrode.

Referring to FIGS. 26 and 27, the third wiring part 313 may have a set length L1. For example, the length L1 of the third wiring part 313 may be 400 μm or more. In detail, the length L1 of the third wiring part 313 may be 400 μm to 600 μm, 430 μm to 570 μm, 450 μm to 550 μm, or 480 μm to 520 μm.

If the length L1 of the third wiring part 313 is less than 400 μm, a size of the third wiring part 313 becomes smaller than a size of the inspection equipment. As a result, the wiring electrode cannot be easily inspected through the inspection equipment. In addition, if the length L1 of the third wiring part 313 exceeds 600 μm, a length of the wiring electrode whose tilting angle is limited increases. Accordingly, the area where the wiring electrode is disposed can increase. As a result, the area of the fingerprint sensor package can increase.

In addition, the third wiring part 313 can be tilted at a set angle. In detail, the third wiring part 313 has an angle (θ1) set with respect to an axis AX direction. The axis AX direction is a direction perpendicular to a moving direction of the inspection equipment. The axis AX direction is a direction perpendicular to a folding axis FAX direction. The axis AX direction is the first direction 1D.

The third wiring part 313 may be inclined at an angle of less than 10° with respect to the axis AX. In detail, the third wiring part 313 may be inclined at an angle of 0° to less than 10°, 0° to 8°, 0° to 6°, 0° to 4°, or 0° to 2° with respect to the axis AX. A fact that the third wiring part 313 is inclined at an angle of 0° with respect to the axis AX means that the third wiring part 313 extends in the axis direction.

If the third wiring part 313 is inclined at an angle exceeding 10° with respect to the axis AX, the inspection equipment may come into contact with an adjacent wiring electrode while moving. Accordingly, the inspection equipment cannot easily check for an open or short circuit of the wiring electrode.

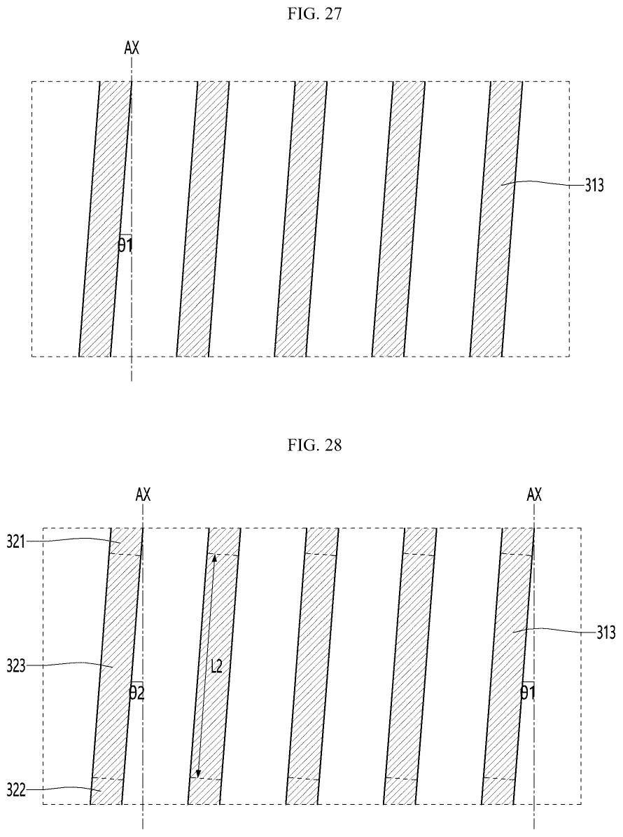

FIG. 28 is an enlarged view of region E of FIG. 22.

Referring to FIG. 28, the second wiring electrode 320 is divided into a fourth wiring part 321, a fifth wiring part 322, and a sixth wiring part 323 according to the position. The fourth wiring part 321 is connected to the second sensing electrode 220. The fifth wiring part 322 is connected to the chip CH.

The sixth wiring part 323 is disposed between the fourth wiring part 321 and the fifth wiring part 322. The sixth wiring part 323 is a test region of the wiring electrode.

That is, the sixth wiring part 323 is a region where the open or short of the wiring electrode is tested by the test equipment.

The sixth wiring part 323 may have a set length L2. For example, the length L2 of the sixth wiring part 323 may be 400 μm or more. In detail, the length L2 of the sixth wiring part 323 may be 400 μm to 600 μm, 430 μm to 570 μm, 450 μm to 550 μm, or 480 μm to 520 μm.

If the length L2 of the sixth wiring part 323 is less than 400 μm, a size of the sixth wiring part 323 becomes smaller than a size of the inspection equipment. Accordingly, the wiring electrode cannot be easily inspected through the inspection equipment. In addition, if the length L2 of the sixth wiring part 323 exceeds 600 μm, the area where the wiring electrode is disposed may increase due to the increase in the length of the wiring electrode whose tilting angle is limited. Accordingly, the area of the fingerprint sensor package may also increase.

In addition, the sixth wiring part 323 may be tilted at a set angle. In detail, the sixth wiring part 323 has a set angle (θ2) with respect to an axis AX direction. The axis AX direction is a direction perpendicular to a moving direction of the inspection equipment. The axis AX direction is a direction perpendicular to the folding axis FAX direction. The axis AX direction is the first direction 1D.

The sixth wiring part 323 may be inclined at an angle of less than 10° with respect to the axis AX. In detail, the sixth wiring part 323 may be inclined at an angle of 0° to less than 10°, 0° to 8°, 0° to 6°, 0° to 4°, or 0° to 2° with respect to the axis AX. The sixth wiring part 323 being inclined at an angle of 0° with respect to the axis AX means that the sixth wiring part 323 extends in a direction of the axis.

If the sixth wiring part 323 is inclined at an angle exceeding 10° with respect to the axis AX, the inspection equipment may come into contact with an adjacent wiring electrode while moving. Accordingly, the inspection equipment cannot easily measure an open or short circuit of the wiring electrode.

The third wiring part 313 and the sixth wiring part 323 may be disposed facing each other. In detail, the third wiring part 313 and the sixth wiring part 323 may be disposed facing each other in the second direction. Accordingly, the first wiring electrode 310 and the second wiring electrode 320 may be simultaneously inspected through the inspection equipment. Therefore, an inspection process time is reduced.

An angle (θ1) of the third wiring part 313 and an angle (θ2) of the sixth wiring part 323 may be the same or different. For example, a difference between the angle (θ1) of the third wiring part 313 and the angle (θ2) of the sixth wiring part 323 may be 0° to less than 10°. If the difference between the angle (θ1) of the third wiring part 313 and the angle (θ2) of the sixth wiring part 323 exceeds 10°, the inspection equipment may interfere with the adjacent electrode at any one wiring electrode during the process of simultaneously inspecting the first wiring electrode 310 or the second wiring electrode 320. Accordingly, the accuracy of the inspection process may decrease.

Hereinafter, the present invention will be described in more detail through an experimental example.

### EXPERIMENTAL EXAMPLE

A polyimide substrate is prepared. A sensing electrode is disposed on the fingerprint sensing region, and a chip is disposed on the chip mounting region. Then, a wiring electrode is disposed on the non-valid region. Then, one region of the wiring electrode connecting the sensing electrode and the chip is set as an inspection region. A length of the inspection region is 400 μm.

Next, while adjusting the angle of the inspection region, the wiring electrode is inspected with a wire probe. When the wire probe moves, if it comes into contact with the adjacent wiring electrode, it is judged as NG. Also, if it does not come into contact, it is judged as OK.

TABLE 1

| | pitch | width | gap | angle(°) | | | | | |
|---|---|---|---|---|---|---|---|---|---|
| | (μm) | (μm) | (μm) | 10 | 8 | 6 | 4 | 2 | 0 |
| Experimental | 22 | 10 | 12 | NG | NG | OK | OK | OK | OK |
| example1 | | | | | | | | | |
| Experimental | 22 | 9 | 13 | NG | NG | OK | OK | OK | OK |
| example2 | | | | | | | | | |
| Experimental | 22 | 8 | 14 | NG | NG | OK | OK | OK | OK |
| example3 | | | | | | | | | |
| Experimental | 22 | 7 | 15 | NG | NG | OK | OK | OK | OK |
| example4 | | | | | | | | | |
| Experimental | 23 | 11 | 12 | NG | OK | OK | OK | OK | OK |
| example5 | | | | | | | | | |
| Experimental | 23 | 10 | 13 | NG | OK | OK | OK | OK | OK |
| example6 | | | | | | | | | |
| Experimental | 23 | 9 | 14 | NG | OK | OK | OK | OK | OK |
| example7 | | | | | | | | | |
| Experimental | 2 | 8 | 15 | NG | OK | OK | OK | OK | OK |
| example8 | | | | | | | | | |

Referring to Table 1, when an angle of the inspection region is 10° or more, the probe inspection equipment moves and comes into contact with the adjacent wiring electrode. Accordingly, a status of whether the wiring electrode is open or shorted cannot be accurately measured through the inspection equipment. On the other hand, when the angle of the inspection region is less than 10°, the probe inspection equipment moves and does not come into contact with the adjacent wiring electrode. Accordingly, a status of whether the wiring electrode is open or shorted can be accurately measured through the inspection equipment.

The fingerprint sensor package can be used in various electronic devices.

For example, referring to FIG. 29, the fingerprint sensor package can be applied to a flexible touch window that bends. The touch window can be applied to a touch device.

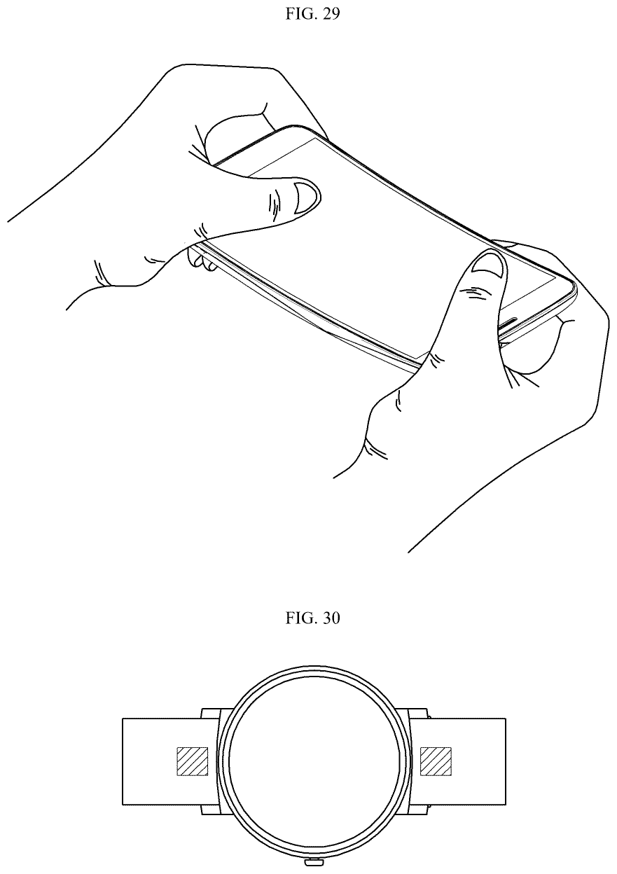

Referring to FIG. 30, the fingerprint sensor package can be applied to various wearable touch devices.

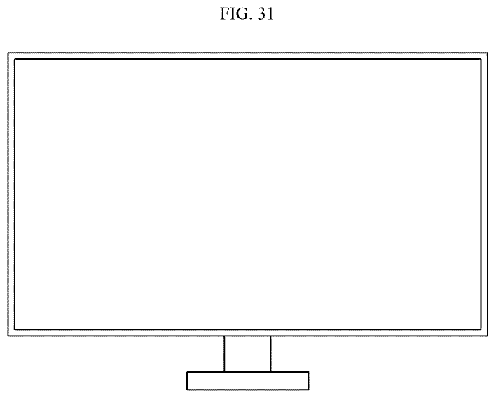

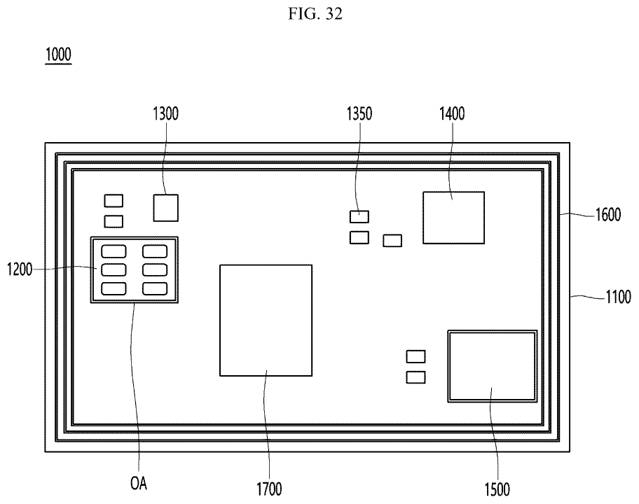

Referring to FIG. 31, the fingerprint sensor package can be applied to various electronic devices including displays such as TVs, monitors, and laptops.

Referring to FIG. 32, the fingerprint sensor package can be applied to a smart card for fingerprint recognition.

Referring to FIG. 32, the smart card 1000 for fingerprint recognition includes a card body 1100, a circuit board 1200 accommodated in the card body 1100, a chip 1300, a microcontroller unit (MCU, 1400), a connection circuit pattern 1350 electrically connecting the chip 1300 and the micro control unit 1400, a fingerprint sensor package 1500, an antenna 1600, and a battery 1700.

The circuit board 1200 is accommodated in the card body 1100. The card body 2000 includes an opening OA for accommodating the circuit board 1200. The circuit board 1200 is inserted into the opening OA.

Accordingly, one of one surface and another surface of the circuit board 1200 is exposed to an outside of the smart card for fingerprint recognition. The circuit board 1200 may have an IC chip mounted thereon.

The smart card for fingerprint recognition includes the fingerprint sensor package 1500 described above. The fingerprint sensor package 1500 recognizes a user's fingerprint. In addition, it matches the fingerprint information stored in the chip 1300 with the fingerprint.

When the user's finger comes into contact with the fingerprint sensor package 1500, power is supplied to the micro control unit 1300 from the battery 1700. The fingerprint sensor package 1500 supplied with power by the micro control unit 1300 is driven.

Then, the micro control unit 1300 receives the recognized fingerprint information through the fingerprint sensor package 1500. Then, an authentication process of the recognized fingerprint information is performed.

If the recognized fingerprint information matches the fingerprint information stored in the chip 1300, the circuit board 1200 is activated and a function of the fingerprint recognition smart card is activated.

If the recognized fingerprint information does not match the fingerprint information stored in the chip 1300, the circuit board 1200 is deactivated and the function of the fingerprint recognition smart card is deactivated.

The fingerprint recognition smart card may include an antenna 1600. Accordingly, the fingerprint recognition smart card may operate as a contactless card.

The characteristics, structures and effects described in the embodiments above are included in at least one embodiment but are not limited to one embodiment. Furthermore, the characteristics, structures, and effects and the like illustrated in each of the embodiments may be combined or modified even with respect to other embodiments by those of ordinary skill in the art to which the embodiments pertain. Thus, it should be construed that contents related to such a combination and such a modification are included in the scope of the embodiment.

The above description has been focused on the embodiment, but it is merely illustrative and does not limit the embodiment. A person skilled in the art to which the embodiment pertains may appreciate that various modifications and applications not illustrated above are possible without departing from the essential features of the embodiment. For example, each component particularly represented in the embodiment may be modified and implemented. In addition, it should be construed that differences related to such changes and applications are included in the scope of the embodiment defined in the appended claims.

1-10. (canceled)

11. A fingerprint sensor substrate comprising:
a substrate;
a plurality of pad parts disposed on the substrate; and
a wiring part connected to at least one pad part among the plurality of pad parts,
wherein the plurality of pad parts includes a first pad part, a second pad part, a third pad part, a fourth pad part, and a fifth pad part spaced apart from each other,
wherein the wiring part includes:
a first wiring part connected to the third pad part and extending from the third pad part to an end of the substrate; and
a second wiring part including a second-first wiring part connecting between the third pad part and the fifth pad part, and a second-second wiring part connected to the fifth pad part and extending from the fifth pad part to an end of the substrate.

12. The fingerprint sensor substrate of claim 11, comprising:
a first sensing electrode disposed on a first surface of the substrate and extending in a first direction;
a second sensing electrode disposed on a second surface of the substrate and extending in a second direction intersecting the first direction;
a first wiring electrode connected to the first sensing electrode; and
a second wiring electrode connected to the second sensing electrode,
wherein the first sensing electrode and the second sensing electrode are disposed on a valid region of the substrate,
wherein the first wiring electrode and the second wiring electrode are disposed on a non-valid region of the substrate.

13. The fingerprint sensor substrate of claim 12, wherein the substrate includes a first component mounting region and a second component mounting region,
wherein the first pad part is disposed inside the first component mounting region and connected to the first wiring electrode,
wherein the second pad part is disposed inside the first component mounting region and connected to the second wiring electrode,
wherein the third pad part is disposed inside the second component mounting region, and
wherein the fifth pad part is disposed outside the first component mounting region and the second component mounting region.

14. The fingerprint sensor substrate of claim 13, wherein the first wiring part and the second wiring part are disposed on at least one of the first surface and the second surface of the substrate.

15. The fingerprint sensor substrate of claim 11, wherein at least one of the first wiring part and the second-second wiring part has a width of 5 μm to 15 μm.

16. The fingerprint sensor substrate of claim 11, wherein the first wiring part is disposed between adjacent fifth pad parts, and
wherein the second-second wiring part is disposed in a region between the fifth pad part and the end of the substrate.

17. The fingerprint sensor substrate of claim 11, wherein a length of the first wiring part is longer than a length of the second-second wiring part.

18. The fingerprint sensor substrate of claim 11, wherein the first wiring part includes a first-first wiring part disposed on a first surface of the substrate and a first-second wiring part disposed on a second surface opposite to the first surface of the substrate,
wherein the second-second wiring part is disposed on the first surface, and
wherein the first-first wiring part and the first-second wiring part are connected through a via.

19. The fingerprint sensor substrate of claim 18, wherein the first-first wiring part is disposed in a region between the third pad part and the fifth pad part on the first surface,
wherein the first-second wiring part is disposed on the second surface in a region corresponding to a region between adjacent fifth pad parts, and
wherein the second-second wiring part is disposed in a region between the fifth pad part and the end of the substrate.

20. The fingerprint sensor substrate of claim 18, wherein a length of the first-second wiring part is longer than the length of the first-first wiring part, and
wherein the length of the first-second wiring part is longer than a length of the second-second wiring part.

21. A fingerprint sensor package comprising:
a substrate;
a plurality of pad parts disposed on the substrate; and
a dummy part connected to at least one pad part among the plurality of pad parts,
wherein the plurality of pad parts includes a first pad part, a second pad part, a third pad part, a fourth pad part, and a fifth pad part spaced apart from each other,
wherein the dummy part includes:
a first dummy part connected to the third pad part and extending from the third pad part to an end of the substrate; and
a second dummy part including a second-first dummy part connecting between the third pad part and the fifth pad part, and a second-second dummy part connected to the fifth pad part and extending from the fifth pad part to an end of the substrate.

22. The fingerprint sensor package of claim 21, comprising:
a first sensing electrode disposed on a first surface of the substrate and extending in a first direction;
a second sensing electrode disposed on a second surface of the substrate and extending in a second direction intersecting the first direction;
a first wiring electrode connected to the first sensing electrode; and
a second wiring electrode connected to the second sensing electrode,
wherein the first sensing electrode and the second sensing electrode are disposed on a valid region of the substrate,
wherein the first wiring electrode and the second wiring electrode are disposed on a non-valid region of the substrate.

23. The fingerprint sensor package of claim 22, wherein the substrate includes a first component mounting region in which a fingerprint sensor chip is disposed and a second component mounting region in which an MLCC is disposed,
wherein the first pad part is disposed inside the first component mounting region and connected to the first wiring electrode,
wherein the second pad part is disposed inside the first component mounting region and connected to the second wiring electrode,
wherein the third pad part is disposed inside the second component mounting region, and
wherein the fifth pad part is disposed outside the first component mounting region and the second component mounting region.

24. The fingerprint sensor package of claim 23, wherein the first dummy part and the second dummy part are disposed on at least one of the first surface and the second surface of the substrate.

25. The fingerprint sensor package of claim 21, wherein at least one of the first dummy part and the second-second dummy part has a width of 5 μm to 15 μm.

26. The fingerprint sensor package of claim 21, wherein the first dummy part is disposed between adjacent fifth pad parts, and
wherein the second-second dummy part is disposed in a region between the fifth pad part and the end of the substrate.

27. The fingerprint sensor package of claim 21, wherein a length of the first dummy part is longer than a length of the second-second dummy part.

28. The fingerprint sensor package of claim 21, wherein the first dummy part includes a first-first dummy part disposed on a first surface of the substrate and a first-second dummy part disposed on a second surface opposite to the first surface of the substrate,
wherein the second-second dummy part is disposed on the first surface, and
wherein the first-first dummy part and the first-second dummy part are connected through a via.

29. The fingerprint sensor package of claim 28, wherein the first-first dummy part is disposed in a region between the third pad part and the fifth pad part on the first surface,
wherein the first-second dummy part is disposed on the second surface in a region corresponding to a region between adjacent fifth pad parts, and
wherein the second-second dummy part is disposed in a region between the fifth pad part and the end of the substrate.

30. The fingerprint sensor package of claim 28, wherein a length of the first-second dummy part is longer than the length of the first-first dummy part, and
wherein the length of the first-second dummy part is longer than a length of the second-second dummy part.
